(19) United States
(12) Patent Application Publication
(10) Pub. No.: US 2005/0112261 A1
(43) Pub. Date: May 26, 2005

(54) Churros and method for making same

(76) Inventor: Robert J. Davis, Scarborough (CA)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/919,165

(22) Filed: Aug. 16, 2004

Related U.S. Application Data
(60) Provisional application No. 60/523,693, filed on Nov. 21, 2003.

(51) Int. Cl. A23G 1/00

(52) U.S. Cl. 426/556

(57) ABSTRACT

A dough for making a pastry food product, such as a churro, a method for making the dough and a method for making a cooked pastry food product from the dough. The method for making the dough for the pastry food product comprises heating dry ingredients for dough-making to a predetermined temperature; and mixing dry ingredients, substantially maintained at about its' predetermined temperature, with water, wherein the water is at a substantially elevated temperature, to form the dough. The dough absorbs less oil when it is deep-fried compared to a dough made by a conventional method.

### CROSS REFERENCE TO RELATED APPLICATION

This application claims priority based on the Provisional Application Ser. No. 60/523,693, filed Nov. 21, 2003, entitled “Churros and Method for Making Same”, which is expressly incorporated herein by reference.

### FIELD OF THE INVENTION

The present invention relates to a pastry food product. More specifically, it relates to a pastry food product, such as a churro, and a method for making the same.

### BACKGROUND TO THE INVENTION

Churros are a popular dessert food found in various hispanic countries, such as Spain, Mexico and Argentina, and are just beginning their popularity in the U.S. and Canada.

It is believed that Spanish shepherds, in particular, Spanish shepherds who tended a breed of sheep referred to as Churro sheep, first invented churros. As nomads, these shepherds carried very little provisions. Certain staples, such as bread, were considered to be a special treat. In order for these shepherds to better prepare bread, they would form the dough into a tube, which would have a star-shaped or fluted cross-sectional shape, and then fry it. This type of tubular dough allowed the dough to become fully cooked on the inside while providing crispiness to the outside. The modern churro is considered to be a tubular pastry, which is deep-fried and typically covered with sugar and cinnamon. The modern churros also have a cross-sectional shape that is fluted or star-shaped.

A typical method for making a churro involves boiling water and butter in a saucepan, removing it from the heat and quickly stirring in flour and salt. The mixture is stirred vigorously over low heat until the mixture forms a ball. The mixture is removed from the heat and eggs are added. The mixture is then spooned into a pastry bag fitted with a star tip and strips of dough are squeezed into hot oil and deep-fried.

In our health conscious society, methods of making churros have been developed that include baking the dough rather than deep-frying it to obtain a healthier churro with less fat content. The baked churro, however, is not as favorable as the deep-fried churro.

As the demand for churros grows, it would be desirable to have a method for making churros that provides a churro that is a healthier alternative to existing churros but is still just as Favorable.

### SUMMARY OF THE INVENTION

The present invention is directed to a churro or other pastry food product that is a healthier alternative to existing deep-fried pastry food products. The invention is also directed to a method for making these healthier alternatives.

In accordance with one aspect of the present invention, there is provided a method for making a dough for a pastry food product, the method comprising:
heating dry ingredients for dough-making to a predetermined temperature; and
mixing the dry ingredients, substantially maintained at about its' predetermined temperature, with water, wherein the water is at a substantially elevated temperature, to form a dough that absorbs less oil when it is deep-fried compared to a standard dough.

In accordance with another aspect of the present invention, there is provided a dough for making a pastry food product comprising a mixture of dry ingredients and water, wherein the dough absorbs less oil when it is deep-fried compared to a standard dough.

In accordance with yet another aspect of the present invention, there is provided a method for making a churro, the method comprising:
heating dry ingredients for dough-making to a predetermined temperature of from about 35° C. to about 45° C., wherein the dry ingredients comprise flour, shortening, salt and starch;
mixing the dry ingredients, substantially maintained at its' predetermined temperature, with water, wherein the water is at a substantially elevated temperature and the ratio of the dry ingredients to the water is about 2:0.7 to about 2:1.1 based on weight, to form the dough that absorbs less oil when it is deep-fried compared to a standard dough;
cooling the dough to room temperature;
kneading and extruding the dough into at least one tube; and
deep-frying the dough in a cooking oil to provide the churro.

### DETAILED DESCRIPTION OF THE INVENTION

The present invention is directed to a churro or other pastry food product that is a healthier alternative to existing deep-fried pastry food products. The present invention is also directed to a method for making the same.

In general, the method for making a dough to be used for making pastry food products, such as the churro, typically comprises heating dry ingredient(s) for dough-making to a predetermined temperature. The dry ingredient(s), substantially maintained at about its' predetermined temperature, is mixed with water to form dough that absorbs less oil when it is deep-fried compared to a standard dough, wherein the water is at a substantially elevated temperature. In embodiments, the dry ingredient(s) may either be added to the water or the water may be added to the dry ingredient(s), in order to form the dough. In most embodiments, the latter is chosen.

Typically, the method for making pastry food products of the present invention, such as the churro, further comprises kneading the dough and extruding the dough into at least one desired shape and size, typically, into a number of tubes. The kneading and extruding of the dough may occur simultaneously while the extrusion of the dough is taking place. The resulting extruded dough can then be deep-fried in oil, removed and served to the consumer.

The dough of the present invention absorbs notably less oil when it is deep-fried compared to a standard dough made by a conventional method. The conventional method is defined as a method that does not involve heating the dry ingredients(s) to a predetermined temperature and substantially maintaining the dry ingredient(s) at that temperature, as described for the method of the present invention.

In light of this, heating the dry ingredients for dough-making to a predetermined temperature can, therefore, be defined as a temperature that produces a dough that absorbs less oil during deep-frying compared to a standard dough made without heating the dry ingredients.

Several extruded tubes of the dough of the present invention were deep-fried. Similarly, a comparable number of extruded tubes of standard dough were made by the conventional method and deep-fried. The standard dough consumed notably more oil than the dough of the present invention. Therefore, the dough of the present invention produces a healthier pastry food product compared to the conventional dough-making method. Furthermore, since the dough of the present invention uses notably less oil to provide the cooked pastry food product, the cooked pastry food product is less costly to make.

It is understood that the ingredients, amount of ingredients, and times used in the method described herein may be varied in both type and amount, as will be understood with respect to the manufacture of dough.

In one embodiment, the method for manufacturing a dough for the pastry food products, such as the churro, comprises heating a mixture of dry ingredients for dough-making to a predetermined temperature of from about 35° C. to about 45° C., more specifically to a temperature of about 40° C. The mixture of dry ingredients is heated of from about 4 minutes to about 6 minutes, typically for about 5 minutes. The mixture of dry ingredients comprises flour, shortening, salt and starch.

In this same embodiment, water is heated to a substantially elevated temperature. A substantially elevated temperature is defined as a temperature that provides a dough with less oil absorption than the standard dough. While lower temperatures may be contemplated, a temperature of from about 90° C. to about 100° C., more specifically a temperature of about 100° C., is typically used. The water at the substantially elevated temperature is then added to the mixture of dry ingredients, while the mixture of dry ingredients is substantially maintained at its' predetermined temperature of from about 35° C. to about 45° C., specifically about 40° C. The ratio of dry ingredients to water is of from about 2:0.7 to about 2:1.1 based on weight, specifically the ratio is about 2:1 based on weight. The amount of water used is dependent upon atmospheric conditions. For instance, in conditions of high humidity, less water is needed.

The dry ingredients and water are mixed together to obtain a proper dough consistency. The amount of time for mixing will vary depending on a number of factors. For instance, the mixing time depends on whether the mixing is done manually or whether it is done using an electric mixer. It also depends on the amount of water used. Typically, the mixing of the dry ingredients with the water are done using an electric mixer. The dry ingredients and water are usually mixed for about 1 minute to about 2 minutes, more specifically for about 1.5 minutes, using the electric mixer at high speed. Any suitable mixer may be used, such as a double arm mixer or the like.

In this same embodiment, the dough is allowed to cool to room temperature (typically about 20° C. to about 23° C.). Typically, the dough is cooled for about 15 to about 20 minutes.

At this point, the dough may be kneaded and extruded into at least one desired shape and size, typically several tubes with a star-shaped or fluted cross-section. Kneading may be done manually or by utilizing a kneading machine, such as a conventional bread maker, or a Refinadora (made by Jose Luis Blanco, Valladolid, Spain). The kneaded dough is then extruded by, for example, placing the dough in a pastry bag fitted with a star tip, or by using an extrusion machine such as a Churro Maker (made by José Luis Blanco, Valladolid, Spain). This machine may also be used to achieve simultaneous kneading and extrusion to remove synchronous kneading and extruding the dough. The extruded dough is then deep-fried in a suitable cooking oil. In one embodiment, the oil is heated to about 170° C. to about 190° C. The extruded dough is then deep-fried for about 1.5 to about 3 minutes, specifically for about 2.2 minutes. At this stage, the cooked product may be readily served to the consumer.

Alternatively, the cooked product may be frozen and prepared at a later stage. In embodiments, the cooked product may be flash-frozen using a blast chiller to of from about −35° C. to about −45° C., typically to about −40° C., and stored at of from about −15° C. to about −30° C., typically at about −20° C. The frozen cooked product can then be readily heated and served. For instance, the frozen cooked product may be heated in a conventional oven or a toaster oven. The frozen cooked product may or may not be thawed first before heating. Typically, the frozen product is cooked for 1 to 2 minutes at about 300° C.

The dough itself, prior to deep-frying, may be frozen, as described above for the cooked product, and stored. The dough may be frozen at various stages of the method. For instance, the dough may be frozen immediately after the dough is made, or after kneading the dough, or after extruding the dough or even after the simultaneously kneading/extruding the dough. The dough may then be thawed at a later date and, if necessary, the dough may be kneaded/extruded, depending on at which stage the dough was frozen. Subsequently, the dough can be deep-fried.

The cooked product, the frozen cooked product and/or dough may be packaged as kits. In some embodiments, one or more of the cooked product, frozen cooked products or frozen dough may be placed in a packaging, such as a bag, and instructions provided for cooking, performing the remaining stages of the method, and the like.

With respect to the dry ingredients, the flour is typically flour, which may be bleached, may be treated with maturing agents such as ascorbic acid, and/or may comprise nutrient enrichment additives. The flour is usually an enriched wheat flour bleached (flour, malted barley flour, niacin, reduced iron, thiamine mononitrate, riboflavin, and folic acid). In certain embodiments, flour is present of from about 86% by weight to about 96% by weight, typically about 91% by weight.

The shortening is a kind typically used in bakery applications, such as an all purpose vegetable shortening made from hydrogenated or partially hydrogenated vegetable oils such as soybean, canola, corn, cottonseed, sunflower, palm and/or the like. The shortening is usually made from a partially hydrogenated vegetable oil (soybean and/or cottonseed oil). In certain embodiments, the shortening is present of from about 7% by weight to about 3% by weight, typically about 5% by weight.

The starch is also a kind typically used in bakery applications, such as cornstarch, wheat starch or mixtures thereof.

The salt is also a kind suitable for bakery applications, such as sodium chloride or potassium chloride. In certain embodiments, the salt is at most about 2% by weight.

Optional ingredients may be included in the dry ingredients such as sugars, dough conditioners such as ascorbic acid, flavorings, coloring, egg proteins, milk proteins, tricalcium phosphate and yeast and baking powder. For instance, the amount of sugar, colorings and flavorings are variable, depending on the tastes and preferences desired by the consumers.

With respect to one embodiment, the dry ingredients comprise enriched wheat flour bleached (typically about 91% by weight +/−5%), partially hydrogenated vegetable oil (typically about 5% by weight +/−2%), salt (typically at most about 2% by weight), wheat starch, ascorbic acid, natural flavor and tricalcium phosphate 08134.

With respect to the oil for deep-frying, the oil may be any suitable deep-frying oil such as vegetable oil, sunflower oil, olive oil or mixtures thereof. An oil stabilizer, such as MirOil™, may be used as an additive for the deep-frying oil to extend the life of the oil. For instance, the additive allows the dough to be cooked at a lower temperature. If Miroil™ is added to a deep-frying oil, the oil can be heated to about 170° C. rather than about 180° C.

With respect to the cooked pastry food product, it may be sprinkled with sugar, cinnamon, ice-cream may be added and/or other preferred toppings.

In further embodiments, the cooked product may be filled with a desired filling. The filling may be chosen from a wide variety of pastry fillings. Some examples of pastry fillings that may be used are fruit, cheese, chocolate, egg and the like. The fillings used may be a fruit filling such as cherry, strawberry, blueberry, apple and the like, or mixtures thereof.

The above disclosure generally describes the present invention. A more complete understanding can be obtained by reference to the following specific Example. The Example is described solely for purposes of illustration and is not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLE 1

Method for Making a Churro

The mixture of dry ingredients include: enriched wheat flour bleached (flour, malted Barley Flour, niacin, reduced iron, thiamine mononitrate, riboflavin, folic acid), partially hydrogenated vegetable oil (soybean and/or cottonseed oil), salt, cornstarch, ascorbic acid, and natural flavor. Based on 100 Grams of dry ingredients, the dry ingredients more specifically include:

| | | |
|---|---|---|
| Moisture | 12.87 | g |
| Ash | 1.81 | g |
| Calories | 368 | |
| Protein | 11.35 | g |
| Total Carbohydrate | 70.00 | g |
| Total Fiber | 0.00 | g |
| Insoluble Fiber | 0.00 | g |
| Soluble Fiber | 0.00 | g |
| Sugar | 0.00 | g |
| Sugar Alcohols | 0.00 | g |
| Fat | 3.90 | g |
| Saturated Fat | .53 | g |
| Monounsaturated Fat | .94 | g |
| Polyunsaturated Fat | .11 | g |
| Trans Fat | .71 | g |
| Cholesterol | 0 | mg |
| Sodium | 524 | mg |
| Potassium | 96.31 | mg |
| Vitamin A | .00 | IU |
| Vitamin C | .20 | mg |
| Thiamine | .77 | mg |
| Riboflavin | .49 | mg |
| Niacin | 7.27 | mg |
| Calcium | 15.69 | mg |
| Iron | 4.24 | mg |
| Phosphorous | 93.36 | mg |
| Folic Acid | 154.96 | ug |

Water is brought to a boil and while the water is boiling, the dry ingredients are heated to 40° C. for about 5 minutes. For every two kilograms of dry ingredients, about 1.0 liters of water is used. When the dry ingredients and water are at the correct amount and temperature, the dry ingredients and water are mixed together for about 1.5 minutes using an electric mixer to form a dough of a desired consistency.

The dough is cooled to room temperature for about 17 minutes and then put through a kneading machine to remove air bubbles. The kneaded dough is placed in the electronically controlled extruder. The dough is extruded at desired quantities and sizes into a wok-like fryer containing olive oil. The temperature of the olive oil is about 170° C. if MirOil™ is present in the olive oil, and 180° C., without MirOil™. The extruded churros are cooked for about 2 minutes. The cooked churros are removed from the fryer and drained of excess oil. The cooked churros are cooled to room temperature and readily served. Alternatively, the cooked churros are placed in a blast chiller until they are frozen to −40° C. and subsequently stored at about −20° C. The frozen product is cooked for about 1 to 2 minutes at about 300° C. in a conventional oven.

Although preferred embodiments of the invention have been described herein in detail, it will be understood by those skilled in the art that variations may be made thereto without departing from the spirit of the invention.

1. A method for making a dough for a pastry food product, the method comprising:
heating dry ingredients for dough-making to a predetermined temperature; and
mixing the dry ingredients, substantially maintained at about its' predetermined temperature, with water, wherein the water is at a substantially elevated temperature, to form a dough that absorbs less oil when it is deep-fried compared to a standard dough.

2. The method of claim 1, wherein the predetermined temperature is of from about 35° C. to about 45° C.

3. The method of claim 1, wherein the predetermined temperature is about 40° C.

4. The method of claim 1, wherein the heated water is at a temperature of from about 90° C. to about 100° C.

5. The method of claim 4, wherein the heated water is at a temperature of about 100° C.

6. The method of claim 1, wherein the dry ingredients comprise flour, shortening, salt and starch.

7. The method of claim 6, wherein the flour is at least one of wheat flour, bleached, treated with ascorbic acid, and comprises nutrient enrichment additives.

8. The method of claim 6, wherein the shortening is made from a hydrogenated vegetable oil or a partially hydrogenated vegetable oil.

9. The method of claim 8, wherein the hydrogenated or partially hydrogenated vegetable oil is chosen from soybean oil, canola oil, corn oil, cottonseed oil, sunflower oil, and/or palm oil.

10. The method of claim 6, wherein the starch is wheat starch.

11. The method of claim 6, wherein the dry ingredients comprise from about 86% by weight to about 96% by weight flour, from about 7% by weight to about 3% by weight shortening, and at most about 2% by weight salt.

12. The method of claim 6, wherein the dry ingredients further comprise at least one of sugar, flavoring, coloring, egg protein, milk protein, yeast and baking powder.

13. The method of claim 1, wherein the mixture of dry ingredients is heated of from about 4 minutes to about 6 minutes.

14. The method of claim 1, wherein the mixture of dry ingredients is heated for about 5 minutes.

15. The method of claim 1, wherein the ratio of dry ingredients to water is of from about 2:0.7 to about 2:1.1 based on weight.

16. The method of claim 15, wherein the ratio of dry ingredients to water is about 2:1 based on weight.

17. The method of claim 1, wherein the heated water is added to the dry ingredients and mixed.

18. The method of claim 1, wherein the dry ingredients and water are mixed together to obtain a proper dough consistency.

19. The method of claim 18, wherein the dry ingredients and water are mixed using an electric mixer.

20. The method of claim 1, further comprising cooling the dough to room temperature.

21. The method of claim 20, further comprising cooling the dough to room temperature for of from about 15 to about 20 minutes.

22. The method of claim 1, further comprising kneading and extruding the dough into at least one desired shape and size.

23. The method of claim 22, further comprising kneading and extruding the dough into at least one tube.

24. The method of claim 23, wherein the cross-section of said at least one tube is star-shaped or fluted.

25. The method of claim 22, wherein the kneading and extruding is done simultaneously.

26. The method of claim 22, further comprising deep-frying the dough in a cooking oil to provide the cooked pastry food product.

27. The method of claim 26, wherein the cooking oil is heated to of from about 170° C. to about 190° C.

28. The method of claim 27, wherein the dough is deep-fried for of from about 1.5 to about 3 minutes.

29. The method of claim 26, wherein the cooking oil is chosen from vegetable oil, sunflower oil, olive oil or mixtures thereof.

30. The method of claim 26, wherein the cooking oil further comprises an oil stabilizer.

31. The method of claim 26, further comprising filling the cooked food pastry with a filling.

32. The method of claim 31, wherein the filling is chosen from a fruit filling, cheese filling, a chocolate filling, or an egg filling.

33. The method of claim 32, wherein the filling is at least one of cherry, strawberry, blueberry, and apple.

34. The method of claim 26, further comprising freezing the cooked pastry food product.

35. The method of claim 34, wherein the cooked pastry food product is flash-frozen to of from about −35° C. to about −45° C.

36. The method of claim 35, wherein the cooked pastry food product is flash-frozen to about −40° C.

37. The method of claim 1, further comprising freezing the dough.

38. The method of claim 22, further comprising freezing the dough.

39. The method of claim 24, further comprising freezing the dough.

40. The method of claim 39, wherein the dough is flash-frozen to of from about −35° C. to about −45° C.

41. The method of claim 26, wherein the cooked pastry food product is a churro.

42. The method of claim 34, wherein the cooked pastry food product is a churro

43. A dough made according to the method of claim 1.

44. A cooked pastry food product made according to the method of claim 22.

45. The cooked pastry food product of claim 44, wherein the cooked pastry food product is a churro.

46. A kit for making at least one cooked pastry food product comprising:
at least one frozen cooked pastry food product according to claim 34; and
instructions for preparing said at least one frozen cooked pastry food product for consumption.

47. The kit of claim 46, wherein the instructions comprise instructions for cooking said at least one frozen cooked pastry food product, optionally thawed, in a conventional oven or toaster oven.

48. The kit of claim 46, wherein the instructions comprise instructions for cooking said at least one frozen cooked pastry food product in the conventional oven or the toaster oven, wherein said at least one frozen cooked pastry food product is cooked at about 300° C.

49. A dough for making a pastry food product comprising a mixture of dry ingredients and water, wherein the dough absorbs less oil when it is deep-fried compared to a standard dough.

50. The dough of claim 49, wherein the dry ingredients comprise flour, shortening, salt and starch.

51. The dough of claim 50, wherein the flour is at least one of wheat flour, bleached, treated with ascorbic acid, and comprises nutrient enrichment additives.

52. The dough of claim 50, wherein the shortening is made from a hydrogenated vegetable oil or a partially hydrogenated vegetable oil.

53. The dough of claim 52, wherein the hydrogenated vegetable oil is chosen from soybean oil, canola oil, corn oil, cottonseed oil, sunflower oil, and/or palm oil.

54. The dough of claim 50, wherein the starch is wheat starch.

55. The dough of claim 50, wherein the dry ingredients comprise from about 86% by weight to about 96% by weight flour, from about 7% by weight to about 3% by weight shortening, and at most about 2% by weight salt.

56. The dough of claim 50, wherein the dry ingredients further comprise at least one of sugar, flavoring, coloring, egg protein, milk protein, yeast and baking powder.

57. The dough of claim 49, wherein the ratio of dry ingredients to water is about 2:0.7 to about 2:1.1 based on weight.

58. The dough of claim 57, wherein the ratio of dry ingredients to water is about 2:1 based on weight.

59. A cooked pastry food product made from the dough according to claim 49.

60. The cooked pastry food product of claim 59, where in the cooked pastry food product is a churro.

61. A method for making a churro, the method comprising:
heating dry ingredients for dough-making to a predetermined temperature of from about 35° C. to about 45° C., wherein the dry ingredients comprise flour, shortening, salt and starch;
mixing the dry ingredients, substantially maintained at its' predetermined temperature, with water, wherein the water is at a substantially elevated temperature and the ratio of the dry ingredients to the water is about 2:0.7 to about 2:1.1 based on weight, to form the dough that absorbs less oil when it is deep-fried compared to a standard dough;
cooling the dough to room temperature;
kneading and extruding the dough into at least one tube; and
deep-frying the dough in a cooking oil to provide the churro.

62. The dough of claim 61, wherein the dry ingredients comprise from about 86% by weight to about 96% by weight flour, from about 7% by weight to about 3% by weight shortening, and at most about 2% by weight salt.

63. The method of claim 61, wherein the dry ingredients further comprise at least one of sugar, flavoring, coloring, egg protein, milk protein, yeast and baking powder.

64. The method of claim 61, wherein the cross-section of said at least one tube is star-shaped or fluted.

65. The method of claim 61, further comprising filling the churro with a filling.

66. The method of claim 61, further comprising freezing the churro.

67. A kit for making at least one churro comprising:
at least one frozen churro according to claim 61; and
instructions for preparing said at least one churro for consumption.

68. The kit of claim 67, wherein the instructions comprise instructions for cooking said at least one frozen churro, optionally thawed, in a conventional oven or toaster oven.
